(19) United States
(12) Patent Application Publication
(10) Pub. No.: US 2015/0345003 A1
(43) Pub. Date: Dec. 3, 2015

(54) METAL MEMBER OF A MOVING SYSTEM OF AN INTERNAL COMBUSTION ENGINE AND METHOD FOR MANUFACTURING THE METAL MEMBER

(71) Applicants: MAHLE Metal Leve S/A, Jundiaí - SP (BR); MAHLE International GmbH, Stuttgart (DE)

(72) Inventors: Denys Flores, Sao Paulo (BR); Juliano Avelar Araujo, Jundiai (BR)

(21) Appl. No.: 14/427,629

(22) PCT Filed: Sep. 11, 2013
(86) PCT No.: PCT/BR2013/000352

§ 371 Date: Aug. 14, 2015

(30) Foreign Application Priority Data
Sep. 12, 2012 (BR) BR1020120230135

(51) Int. Cl. C23C 10/04; F16J 9/26; F02F 1/00; C21D 1/09

(52) U.S. Cl. CPC C23C 10/04; C21D 1/09; F16J 9/26; F02F 1/004; F05C 2251/10

(57) ABSTRACT

A metallic member for a mobile system of an internal combustion engine may include a body defining a crystallographic structure. The crystallographic structure may include an outer layer, a substrate and a saturated zone between the outer layer and the substrate. An external element may be dispersed at least partially through the crystallographic structure of the body. The body may be subjected to a superficial hardening treatment from infiltrating the external element into the crystallographic structure of the body via a laser beam penetrating at least one portion of an outer surface of the outer layer of the body.

### CROSS REFERENCE TO RELATED APPLICATIONS

This application claims priority to Brazilian Patent Application No. 1020120230135, filed Sep. 12, 2012, and International Patent Application No. PCT/BR2013/000352, filed Sep. 11, 2013, both of which are hereby incorporated by reference in their entirety.

### TECHNICAL FIELD

The present invention relates to a process of manufacture of a metallic member of a mobile system of an internal combustion engine (especially, a piston ring) and a metallic member submitted to such process of manufacture.

Said process of manufacture is configured for changing the physicochemical properties of the material which constitutes said metallic member, providing a component provided with a bigger efficiency in terms of operation and greater longevity in terms of use.

### BACKGROUND

In an internal combustion engine (whether of Diesel cyclo type, or Otto cyclo, of two or four times) the piston ring is a part that accomplishes the function to seal the space between the sleeve and the piston, isolating the combustion chamber of the other internal components of the engine.

The piston ring is radially disposed in the base of the cylinder, preventing the combustion gases from escaping outside the combustion chamber toward to the crankcase and avoiding that the oil of the engine penetrates the combustion chamber in an inverse way. It is possible to have more than one piston ring surrounding a single piston, being quite common the use of two or three rings arranged in parallel in the base of the piston.

In order to comply with efficiency such role, the piston ring should have an outer finishing meticulously flat and should be constituted of a material of relatively high hardness. That is because, according to experimental findings, the higher the hardness of the outer surface of the ring

especially, the surface which is in contact with the inner face of the sleeve

the greater its efficiency in terms of sealing.

In order to keep flat the finishing of the ring and to give it greater hardness, the piston rings (normally constituted of carbon steel) are submitted to one or more superficial treatments, such as:

PVD—Physical Vapor Deposition;

CVD—Chemical Vapor Deposition;

Nitriding;

(Among others)

In general, said treatments promote a bigger degree of hardness in determine metallic surface through the insertion of external elements in the midst of the crystallographic structure of the metal. Said external elements can be, for instance, the atom of nitrogen or carbon.

It is noted that, said processes of finishing do not interfere in the internal hardness of the metal, that is, the hardness in the inner layers of a metal part. Such superficial treatments are capable of modifying only the outer layer of a part, forming a micrometric thickness film, supersaturated of external elements, through the crystallographic structure of the original metal (hereinafter, coating film).

Nevertheless, despite of increasing the degree of hardness of a particular metallic surface, said superficial treatments, per se, are not capable of promoting the creation of a piston ring highly efficient and durable. That is because, after having said treatments performed, the rings become pretty fragile, especially at the intersection points between the outer layer (that is, the coating film) and the core of the metal part.

Said fragility is due to, especially, the heterogeneity which is established between said two material layers. As said two layers present different material (one has a bigger concentration of external elements than the other one) they also disclose different physical properties, such as: coefficient of expansion, resistance, compression ratio, etc.

This is where a big problem of the piston rings of the prior art lies. The line which divides the two layers, defined by the contrast between the outer layer and the inner layer of the metal, can easily originate a crack. Said crack can be propagated by the part, causing the scuffing/detachment of the metal and, consequently, the total loss of the outer layer of the piston ring.

By losing its outermost layer, the piston ring abruptly decreases its longevity and efficiency, allowing an undesirable fluid exchange between the combustion chamber and the innermost region of the engine block and increasing the susceptibility to the wear on the outer face of the ring. Therefore, it is necessary to have a solution to said problem. A solution which aims to increase the longevity and efficiency of a piston ring, through a physical or chemical treatment to the crystallographic structure of a piston ring already hardened.

The present invention aims the design of a durable and efficient piston ring in terms of sealing.

The present invention also aims the design of a process of manufacturing the durable and efficient piston ring in terms of sealing.

The present invention also aims the design of a metallic member of a mobile system of an engine to the internal combustion, which discloses efficiency and durability in terms of use.

At last, the present invention also aims the conception of a method of manufacturing of a metallic member of a mobile system of a combustion engine, such as disclosed above.

### SUMMARY

The objectives of the present invention are achieved by a metallic member of a mobile system of an internal combustion engine, characterized by the fact that said metallic member is subjected to a superficial hardening treatment consisting in infiltrating an external element into the crystallographic structure of the metal by means of a process involving laser, in at least one portion of its outer surface.

The objectives of the present invention are also achieved by a process of manufacturing a metallic member of a mobile system of an internal combustion engine, characterized by consisting in one single step which comprises two operations that occur simultaneously, namely: Conducting a surface hardening treatment by infiltration of an external element through the crystallographic structure of the metal; and the formation of a diffusion zone between the original substrate of the metal and its saturated zone through the application of a laser under its outer surface.

### BRIEF DESCRIPTION OF THE DRAWINGS

The present invention will be hereinafter further described based on an embodiment represented in the drawings. The figures show:

FIG. 1—is a view of a cross section of a first sample of a piston ring which was subjected to the process of treatment of the present invention.

FIG. 2—is a view of a cross section of a second sample of a piston ring which was subjected to the process of treatment of the present invention.

FIG. 3—is a graph which discloses the resistance index to the scuffing index of the material of a piston ring of the present invention, in comparison to a piston ring of the prior art.

FIG. 4—is a graph which discloses the variation of the hardness of the material which composes the piston ring, according to analyzed in its outmost layer toward its core.

### DETAILED DESCRIPTION

The basic principle of the manufacturing process of the piston ring 1 of the present invention consists in the application of a laser of high intensity under the outer radial face of the piston ring 1.

When applied under correct conditions, the laser causes the external element which is saturated in the outmost radial layer of the ring to be distributed in the inner layers of said material, creating thus a concentration gradient of the external element throughout the successive layers of material constituting such ring.

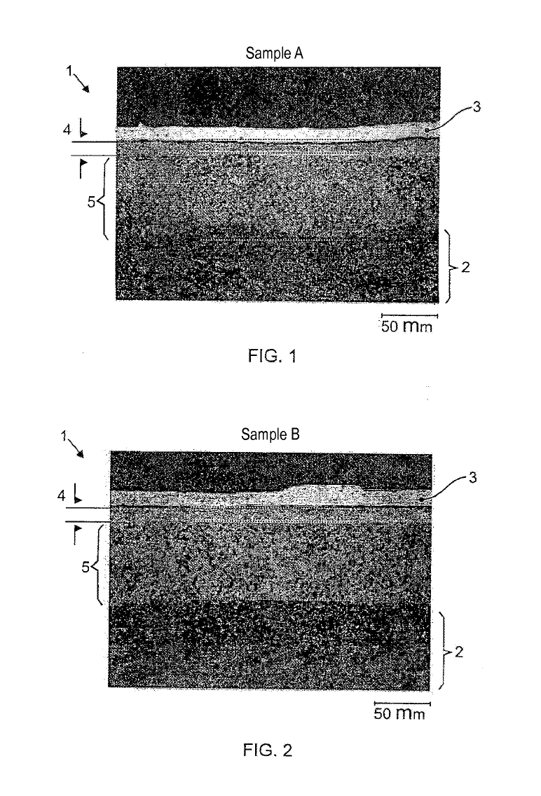

FIGS. 1 and 2 of this specification disclose micrographs of two samples of piston rings which were subjected to the treatment using laser of the present invention.

Through said two photographs it is possible to perceive: An outermost range, which corresponds to the cross-section of an aluminum sheet 3 (only used to for allow the differentiation of the Bakelite—upper black region—of the beginning of the coating); a “saturated zone 4”, or coating film; a “substrate 2” which corresponds to the metal constituent of the piston ring 1 in its original form (generally carbon steel); and a “diffusion zone 5” which corresponds to a hybrid material between the substrate 2 and the saturated zone 4.

Said diffusion zone 5 can be defined as an intermediate layer between the saturated zone 4 and the substrate 2, which is formed after the process of application of the laser under the outer radial face of the piston ring 1.

It is noted that, when promoting cladding/alloy formation between the materials of substrate 2 and the coating film, laser dissolves the critical spots susceptible to cracks and breakage originally existing between the coating film and the core of piston ring 1.

Diffusion zone 5 creates a gradual transition between the physical properties of the coating film and the substrate 2 (or core) of the material. This is where the main quality attributed to the application of laser to piston ring 1 resides.

An experiment conducted with a sample of a piston ring 1 showed that, starting from the outer radial surface of the ring up to 100 microns in depth (penetrating into the center of this ring radial) the hardness of its material is gradually decreased, as shown in the graph of FIG. 4 of this specification.

A secondary feature resulting from the application of laser on piston ring 1, in addition to the creation of diffusion zone 5, is the refinement of the grains of its metallic structure in its outer radial surface.

In the outer radial face of piston ring 1, the face most affected by laser application, there is a temporary fusion of metal. This fusion, because it occurs only in a micrometric thickness range of the outer face of the ring is rapidly cooled by the rest of piston ring 1 (which is at room temperature). This heating followed by rapid cooling is what causes the reduction of the grains of the metallic structure, a phenomenon known as grain refinement.

By reducing the size of the grains of the metallic structure, the laser causes further increase in fracture resistance of the ring. This is due to the fact that all metallic structure with reduced grain size increases elastic deformation limit avoiding unwanted occurrences such as scuffing/detachment of the surface of the material.

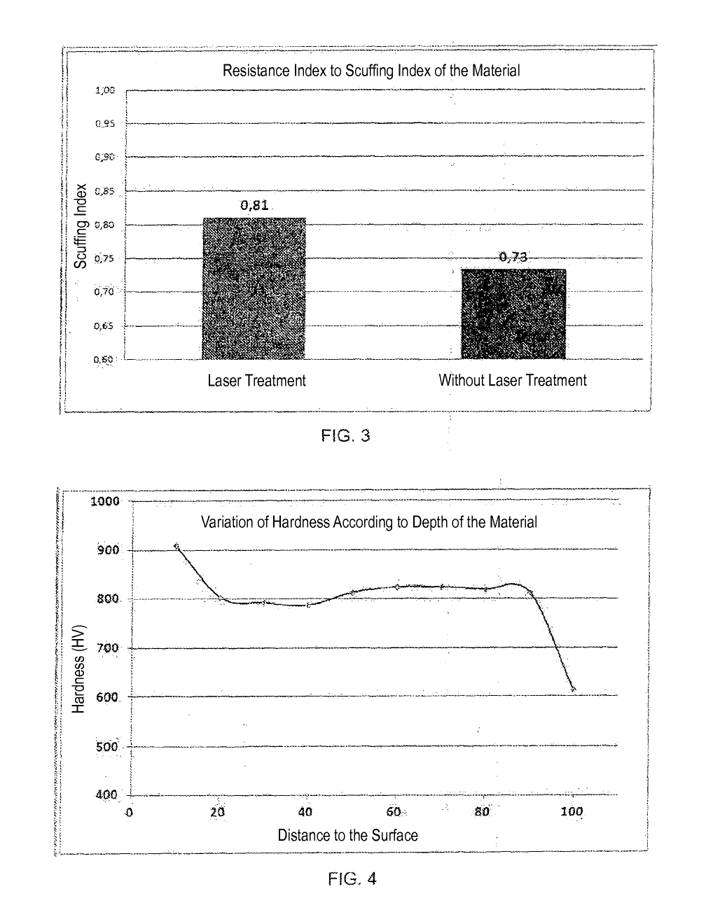

After the laser application process, it is common for the piston rings samples to show a scuffing index much higher than that presented by conventional rings of the prior art, as shown in the graph in FIG. 3 of this specification.

The laser should be applied at a rate and intensity to enable fusion of the outer layer of the ring, but does not cause evaporation of the element. It is worth noting that the lower the speed of laser application, the greater the degree of diffusion of the outer element, and consequently more diluted, that is, less saturated the film coating material will be. Preferably, the speed and intensity of laser application should be sufficient to form a diffusion zone 5 with approximately 80 μm (considering any value between 30 and 150 microns a reasonable value).

However, the laser intensity and speed of application are not the only factors that affect the outcome of the application on the external face of the ring. In addition to laser speed and intensity, other factors affecting the efficiency of this treatment are: the angle of incidence of the laser, the gaseous environment of the laser operating room, and the thickness of coating film.

Preferably, the most suitable parameters for the laser application are indicated in the following table:

Preferable parameters for application:

| | |
|---|---|
| Angle of incidence of the | between 45° and 90° |
| laser: | |
| Application speed of the | between 2 and 20 mm/s |
| laser: | |
| power of the laser: | between 2 and 8 KW |
| defocusing: | between 8 and 300 mm |
| model of the laser | CO2 or Nd: YAG or diode |
| emitting device: | HDPL or fiber |

Focused on the initial surface treatment process to which piston ring 1 is subjected, it is known that this laser treatment process can produce good results in metal rings whose coating film is saturated with cobalt, nickel, chromium, boron, nitrogen, carbon or a combination of the same. These elements can be obtained from carbides, sulfides and nitrides, just to name some forms of applicable industrial supplies.

Anyway, it should be noted that the process of applying laser of the present invention is not restricted to rings hardened by infiltration of these external elements, and other application forms are possible provided they include the diffusion concept defined in this specification.

Regarding materials that should preferably (not necessarily) constitute substrate 2 of piston ring 1 are metals or metal alloys consisting mainly of iron or aluminum.

In a preferred embodiment, the process of hardening the outer layer of piston ring 1 and the application of laser constitute one single step. In other words, the insertion of the external element in the midst of the crystallographic structure of the metal occurs simultaneously with the application of laser so that the two following phenomena occur simultaneously: hardening the outer face of the ring and creating a gradient (i.e., a diffusion zone 5).

This operation can be carried out, for example, by spraying a particulate containing the external element on the heated molten metal during laser application.

Note that, through the processes and manufacturing methods disclosed above, the present invention can solve all the problems for which it was intended to solve, namely: the problems of low efficiency in terms of sealing and low longevity of piston ring 1 of the prior art.

The present invention further discloses a secondary advantage due to an ecological benefit it provides in one of its possible embodiments. That is, in the process of inserting the carbon element in the midst of the crystallographic structure of the metal it is possible to use a material named carbon black.

Carbon black is a byproduct of pyrolysis (controlled burning) of automobile tires. Its use in an industrial process such as the present invention is very beneficial to the environment since, by “locking in” the carbon atom in the midst of a crystallographic structure of a metal, the present invention prevents the decomposition of such atoms into carbon dioxide or monoxide, which are very harmful pollutants to the environment.

Finally, it is worth noting that although this specification, up at this point, only makes reference to piston ring 1, it is evident that the manufacturing process described herein can also be applied to any other component of an internal combustion engine.

Among other possible components that can use this manufacturing process are, for example: the sleeve of the piston, the intake and exhaust valves, piston pin and its housing, connecting rod, the various parts of the crankshaft, among other pieces. It is worth noting that any moving piece or piece that is in contact with a piece that moves inside a combustion engine can receive the treatment described in this specification.

Thus, a piston sleeve can receive a surface treatment throughout its inner face (the face that will be in contact with piston ring 1 during operation of the engine) and be subjected to laser application in order to cause the same effects already described herein, namely, the creation of a diffusion zone 5 between the coating film and the core of the material and the grain refinement in proximity to this coating film.

Thus, it should be noted that the present invention, in general, seeks protection for metallic members of a mobile system of an internal combustion engine and processes of manufacturing said metallic members. Among these metallic members of a mobile system, for instance, the piston sleeve and piston ring 1, and other components of a combustion engine that can benefit from the manufacturing process proposed herein.

Since an example of preferred embodiment was described, it should be understood that the scope of protection of the present invention encompasses other possible variations, being limited solely by the content of the appended claims, including the possible equivalents.

1. A metallic member for a mobile system of an internal combustion engine, comprising:
a body defining a crystallographic structure, the crystallographic structure including an outer layer, a substrate and a saturated zone between the outer layer and the substrate; and
an external element dispersed at least partially throughout the crystallographic structure of the body;
wherein the body is subjected to a superficial hardening treatment from infiltrating the external element into the crystallographic structure of the body via a laser beam penetrating at least one portion of an outer surface of the outer layer of the body.

2. The metallic member according to claim 1, wherein the metallic member is a piston ring.

3. The metallic member according to claim 1, wherein the metallic member is a piston sleeve.

4. The metallic member according to claim 1, wherein the substrate includes at least one of iron, aluminum and a metal alloy.

5. The metallic member according to claim 1, wherein the external element includes at least one of cobalt, nickel, chromium, nitrogen, boron and carbon.

6. The metallic member according to claim 1, wherein the external element is composed of at least one of a carbide, a sulfide, a nitride and a carbon black material.

7. The metallic member according to claim 1, further comprising a diffusion zone disposed between the saturated zone and the substrate of the body, the diffusion zone having a thickness ranging between 30 and 150 microns.

8. A process of manufacturing a metallic member for a mobile system of an internal combustion engine, comprising:
providing a body defining a crystallographic structure, the crystallographic structure including an outer layer composed of a first material, a substrate composed of a second material and a saturated zone composed of a third material between the outer layer and the substrate; and
performing the following steps simultaneously:
infiltrating an external element into the crystallographic structure of the body to effect a superficial hardening treatment; and
forming a diffusion zone between the substrate and the saturated zone via applying a laser on an outer surface of the outer layer of the body.

9. The process according to claim 8, wherein applying the laser on the outer surface of the body includes applying the laser with at least one of the follow parameters: an angle of incidence of 45°-90°; an application speed of 2-20 mm/s; a power ranging between 2 and 8 KW; and a defocusing ranging between 8 and 300 mm.

10. The process according to claim 8, wherein the material of the substrate includes at least one of iron and aluminum.

11. The process according to claim 8, wherein the external element includes at least one of cobalt, nickel, chromium, nitrogen, boron and carbon.

12. The process according to claim 11, wherein the saturated zone includes a higher concentration of the external element than the outer layer.

13. The process according to claim 8, wherein infiltrating the external element includes spraying a particulate containing the external element on a heated molten area of the outer surface of the outer layer.

14. The process according to claim 13, wherein the particulate is composed of at least one of a carbide, a sulfide and a carbon black material.

14. The process according to claim 8, wherein forming the diffusion zone includes bonding the third material of the saturated zone with the second material of the substrate to establish a gradient, the gradient of the diffusion zone defining a gradual transition between the third material of the saturated zone and the second material of the substrate.

15. The metallic member according to claim 1, wherein the substrate is composed of a first material composition and the saturated zone is composed of a second material composition different from the first material composition of the substrate.

16. The metallic member according to claim 15, further comprising a diffusion zone disposed between the saturated zone and the substrate, the diffusion zone defining a gradient between the second material composition of the saturated zone and the first material composition of the substrate.

17. The metallic member according to claim 16, wherein the external element is dispersed throughout the outer layer, the saturated zone and the diffusion zone.

18. The metallic member according to claim 1, wherein the external element is dispersed throughout the outer layer and the saturated zone.

19. The metallic member according to claim 18, wherein the saturated zone includes a higher concentration of the external element than the outer layer.

20. A metallic member of an internal combustion engine, comprising:
a body defining a crystallographic structure including:
an outer layer having an outer surface;
a saturated zone disposed between the outer layer opposite the outer surface and a diffusion zone;
the diffusion zone disposed between the saturated zone and a substrate, wherein the substrate includes at least one of iron and aluminum; and
an external element dispersed at least partially throughout the crystallographic structure of the body, wherein the external element infiltrates the crystallographic structure of the body via a laser penetrating at least one portion of the outer surface of the outer layer;
wherein the saturated zone includes a higher concentration of the external element than the diffusion zone, the diffusion zone including a gradient defining a gradual transition between a composition of the saturated zone and the substrate.
